(19) United States
(12) Patent Application Publication
(10) Pub. No.: US 2009/0126489 A1
(43) Pub. Date: May 21, 2009

(54) ACCELERATION SENSOR

(75) Inventors: Kazuhiro Yamada, Aichi-ken (JP); Akira Sumiyashiki, Aichi-ken (JP); Kazuhiko Aihara, Aichi-ken (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: KABUSHIKI KAISHA TOKAI-RIKA-DENKI-SEISAKUSHO, Aichi-ken (JP)

(21) Appl. No.: 12/268,884

(22) Filed: Nov. 11, 2008

(30) Foreign Application Priority Data
Nov. 15, 2007 (JP) 2007-297112

(51) Int. Cl. G01P 15/02

(52) U.S. Cl. 73/514.01

(57) ABSTRACT

In an acceleration sensor, the magnitude of an acceleration of the vehicle is a predetermined value or more, a ball is moved laterally and upward along a supporting surface to rotate a lever upward. Even when the installing angle of a holder sensor is changed according to the type of the vehicle, engaging teeth of a bracket which mesh meshing teeth of the holder sensor are changed. So, the center axis of the supporting surface can be arranged parallel to the up-and-down direction to maintain the detecting performance of the acceleration of the vehicle. Therefore, the change of the bracket according to the type of the vehicle can be unnecessary.

### CROSS-REFERENCE TO RELATED APPLICATION

This application claims priority under 35 USC 119 from Japanese Patent Application No. 2007-297112, the disclosure of which is incorporated by reference herein.

### BACKGROUND OF THE INVENTION

1. Field of the Invention

The present invention relates to an acceleration sensor in which a moving body is movable due to the action of a predetermined acceleration of a vehicle.

2. Description of the Related Art

An acceleration sensor is installed in the seat (seat back) of a vehicle in which a sensor case supports an inertial body and a sensor arm is brought into contact with the upper portion of the inertial body (see Japanese Patent Application Laid-Open (JP-A) No. 11-129866).

When the type of the vehicle to which is installed the acceleration sensor is changed, so the installing angle of the acceleration sensor in the seat width direction and in the seat front-and-rear direction is changed, the sensor case and the sensor arm need to be changed (replaced) to maintain the performance of the acceleration sensor.

Therefore, plural types of the sensor cases and plural types of the sensor arms are necessary, and plural types of molds for manufacturing the sensor cases and the sensor arms are necessary. Thus, the cost is high.

### SUMMARY OF THE INVENTION

In consideration of the above facts, the present invention provides an acceleration sensor, when the installing angle thereof with respect to a vehicle is changed according to the type of the vehicle, which can eliminate the need for changing a supporting portion.

In a first aspect of the invention, an acceleration sensor including: a supporting portion that supports a moving body such that the moving body can be moved by action of a predetermined acceleration of a vehicle; an installation portion to which the supporting portion is installed, a setting angle of the installation portion relative to the vehicle being changed according to a model of the vehicle; and a changing portion that can change an installing angle of the supporting portion relative to the installation portion according to the model of the vehicle.

In a second aspect of the invention, the acceleration sensor in the first aspect of the invention, the changing portion includes: a first engaging portion that is provided at one of the supporting portion or the installation portion; and a second engaging portion that is provided at the other of the supporting portion or the installation portion, and engages with the first engaging portion, and by changing an engaging state of the first engaging portion and the second engaging portion, the installing angle of the supporting portion relative to the installation portion is changed.

In a third aspect of the invention, the acceleration sensor in the second aspect of the invention, the second engaging portion includes at least one tooth, the first engaging portion includes a plurality of teeth which can engage with the tooth of the second engaging portion, and by changing the tooth of the first engaging portion which engages with the tooth of the second engaging portion, the installing angle of the supporting portion relative to the installation portion is changed.

In a fourth aspect of the invention, the acceleration sensor in the third aspect of the invention, the second engaging portion is fixed to the installation portion, and the first engaging portion is provided at the supporting portion.

In a fifth aspect of the invention, the acceleration sensor in the third aspect of the invention, the first engaging portion is fixed to the installation portion, and the second engaging portion is provided at the supporting portion.

In a sixth aspect of the invention, the acceleration sensor in the second aspect of the invention, the second engaging portion configures an internal gear, the first engaging portion configures an external gear that engages with the internal gear, and by changing the engaging state of the internal gear of the second engaging portion and the external gear of the first engaging portion, the installing angle of the supporting portion relative to the installation portion is changed.

In a seventh aspect of the invention, the acceleration sensor in the sixth aspect of the invention, the internal gear includes at least one tooth, the external gear includes a plurality of teeth which can engage with the tooth of the internal gear, and by changing the tooth of the external gear which engages with the tooth of the internal gear, the installing angle of the supporting portion relative to the installation portion is changed.

In an eighth aspect of the invention, the acceleration sensor in the seventh aspect of the invention, the internal gear is fixed to the installation portion, and the external gear is provided at the supporting portion.

In the accelerating sensor in the first aspect of the invention, the supporting portion supports the moving body and the moving body can be moved by the action of a predetermined acceleration of the vehicle. The supporting portion is installed in the installation portion.

When the setting angle of the installation portion relative to the vehicle is changed according to the type of the vehicle, the installing angle of the supporting portion relative to the installation portion can be changed by the changing portion according to the type of the vehicle. When the setting angle of the installation portion relative to the vehicle is changed according to the type of the vehicle, the installing angle of the supporting portion relative to the installation portion can be changed by the changing portion according to the type of the vehicle. So, for example, the setting angle of the supporting portion relative to the vehicle can be constant to maintain the performance of the acceleration sensor. Further, the supporting portion need not be changed.

In the acceleration sensor in the second aspect of the invention, the changing portion has the first engaging portion which is provided in one of the supporting portion and the installation portion, and the second engaging portion which is provided in the other of the supporting portion and the installation portion. The first engaging portion engages the second engaging portion.

The engaging state of the first engaging portion and the second engaging portion is changed to change the installing angle of the supporting portion relative to the installation portion. By a simple configuration, the installing angle of the supporting portion relative to the installation portion can be changed.

### BRIEF DESCRIPTION OF THE DRAWINGS

Embodiments of the invention will be described in detail with reference to the following figures, wherein:

FIG. 1 is a cross-sectional view illustrating an acceleration sensor according to an exemplary embodiment of the invention, seen from one side in the vehicle width direction;

FIG. 2 is a cross-sectional view illustrating the acceleration sensor according to an exemplary embodiment of the invention, seen from one side in the vehicle front-and-rear direction;

FIG. 3 is a side view illustrating a webbing winding device configured by application of the acceleration sensor according to an exemplary embodiment of the invention, seen from one side in the vehicle width direction;

FIG. 4 is a side view illustrating the main portion (the right portion) of the vehicle configured by application of the webbing winding device configured by application of the acceleration sensor according to an exemplary embodiment of the invention, seen from the inside in the vehicle width direction (the left side of the vehicle);

FIG. 5 is a side view illustrating the acceleration sensor according to an exemplary embodiment of the invention when the device up direction (a holder sensor) is inclined to the other side in the vehicle front-and-rear direction, seen from one side in the vehicle width direction;

FIG. 6 is a side view illustrating the webbing winding device configured by application of the acceleration sensor according to an exemplary embodiment of the invention when the device up direction is inclined to the other side in the vehicle front-and-rear direction, seen from one side in the vehicle width direction; and

FIG. 7 is a cross-sectional simplified view illustrating an acceleration sensor according to an exemplary modified embodiment of the invention, seen from one side in the vehicle width direction.

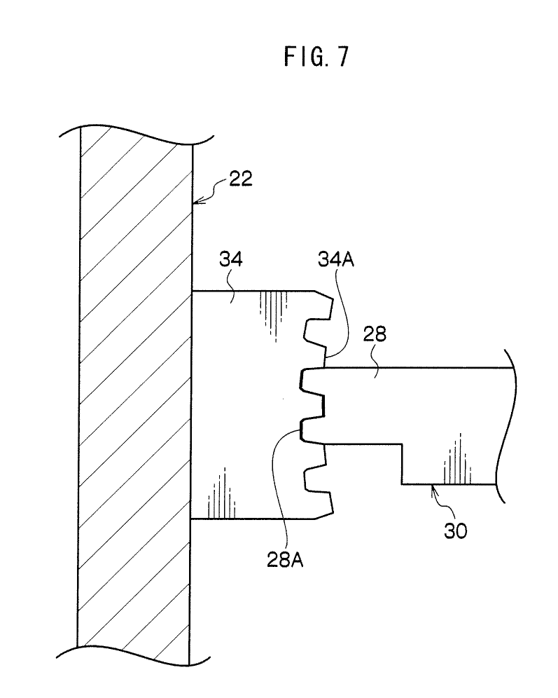

### DETAILED DESCRIPTION OF THE INVENTION

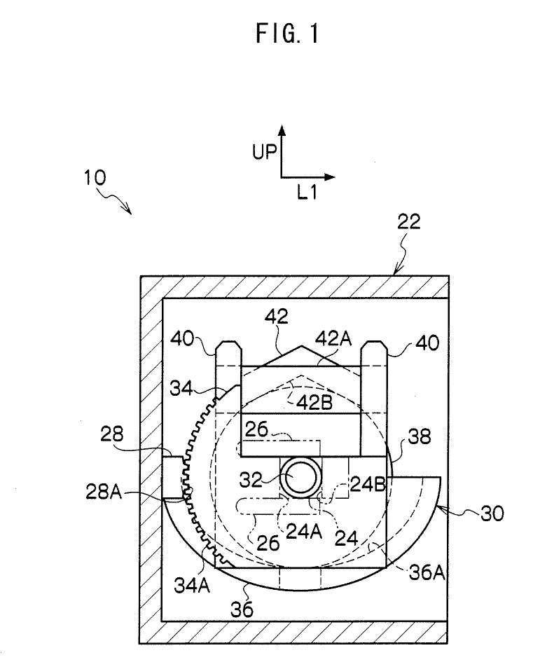

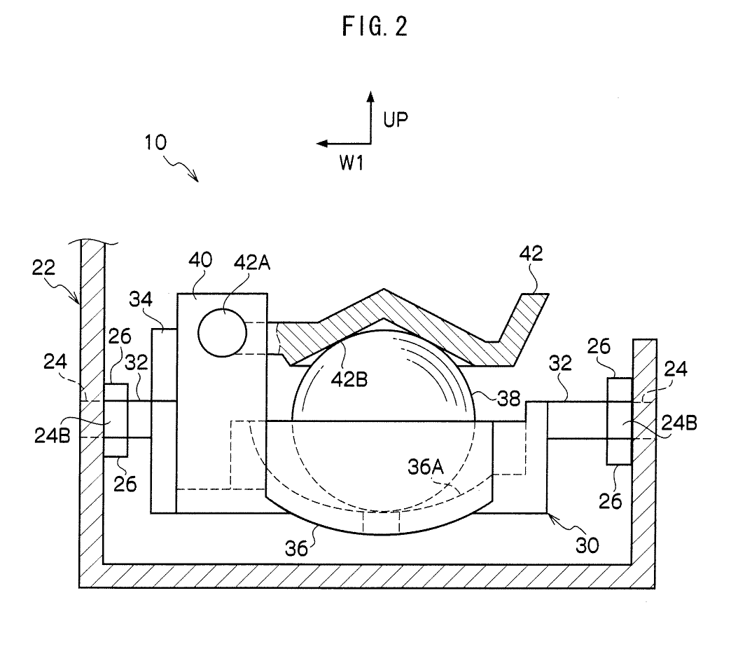

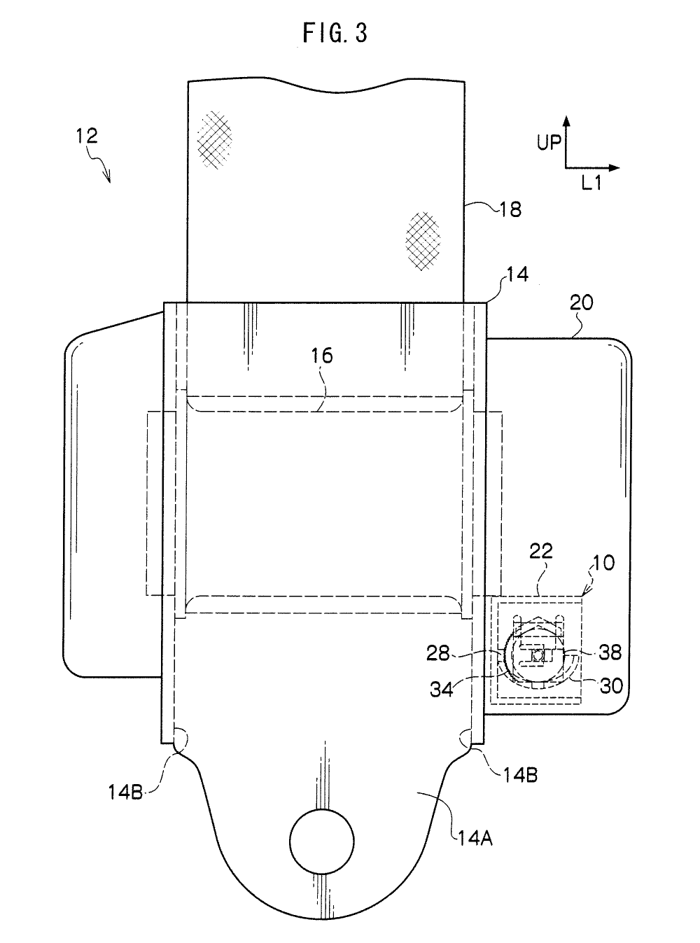

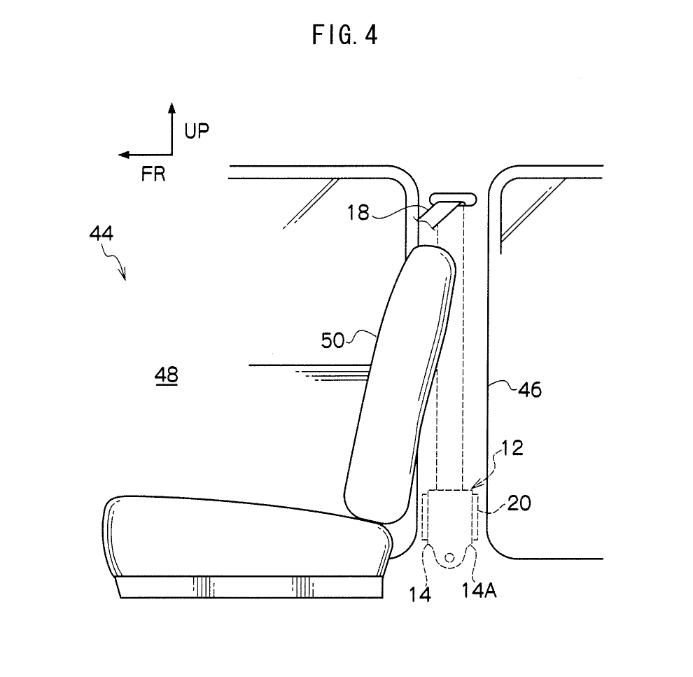

FIG. 1 is a cross-sectional view illustrating an acceleration sensor 10 (V sensor) according to an exemplary embodiment of the invention, seen from one side in the vehicle width direction. FIG. 2 is a cross-sectional view illustrating the acceleration sensor 10, seen from one side in the vehicle front-and-rear direction. FIG. 3 is a side view illustrating a webbing winding device 12 (retractor) configured by application of the acceleration sensor 10, seen from one side in the vehicle width direction. FIG. 4 is a side view illustrating the main portions of a vehicle 44 configured by application of the webbing winding device 12, seen from the inside in the vehicle width direction (the left side of the vehicle). In the drawings, one side in the vehicle front-and-rear direction of the acceleration sensor 10 and the webbing winding device 12 is indicated by an arrow L1, one side in the vehicle width direction of the acceleration sensor 10 and the webbing winding device 12 is indicated by an arrow WI, the front direction of the vehicle is indicated by an arrow FR, and the up direction of the vehicle is indicated by an arrow UP.

The webbing winding device 12 of this exemplary embodiment is installed in the lower end of a pillar 46 (center pillar) to be installed, in the vehicle 44. The pillar 46 is extended in the up-and-down direction and is arranged so as not to be inclined in the vehicle front-and-rear direction. Depending on the type of the vehicle, the pillar 46 may also be extended in the vehicle front-and-rear direction while toward the up, that is, be arranged so as to be inclined in the vehicle front-and-rear direction. The pillars 46 are arranged on the vehicle right and left sides of a vehicle compartment 48. The inclining angles (including 0°) of the pillars 46 in the vehicle front-and-rear direction are the same. The webbing winding device 12 is installed in the lower end of each of the pillars 46. In each of the pillars 46, one side in the vehicle width direction of the webbing winding device 12 is directed to the inside in the vehicle width direction. In the pillar 46 on the right side of the vehicle, one side in the vehicle front-and-rear direction of the webbing winding device 12 is directed to the rear side of the vehicle. In the pillar 46 on the left side of the vehicle, one side in the vehicle front-and-rear direction of the webbing winding device 12 is directed to the front side of the vehicle.

The webbing winding device 12 is provided with a plate shaped frame 14 having U-shaped cross section serving as an installing member. The frame 14 has a planar fixing plate 14A, and a pair of planar opposed plates 14B. The frame 14 is fixed, at the fixing plate 14A, to the lower end of the pillar 46. The webbing winding device 12 is installed in the lower end of the pillar 46 in the state that the device up-and-down direction is parallel to the up-and-down direction along the extending direction of the pillar 46. The fixing plate 14A is arranged perpendicular to the vehicle width direction. The pair of opposed plates 14B is extended perpendicularly from the fixing plate 14A to the outside in the vehicle width direction and are opposed to each other in the vehicle front-and-rear direction.

A substantially cylindrical spool 16 as a winding shaft is rotatably supported between the pair of opposed plates 14B. The rotating shaft direction of the spool 16 is parallel to the vehicle front-and-rear direction. The base end of long belt-shaped webbing 18 (seatbelt) as a belt is retained to the spool 16. The webbing 18 is wound from its base end so as to be housed in the spool 16. The spool 16 is rotated in the winding direction (one side about the shaft) to wind the webbing 18. The spool 16 is rotated in the taking out direction (the other side about the shaft) such that the webbing 18 is able to be taken out. The webbing 18 is taken out upward from the spool 16 along the pillar 46. The webbing 18 is extended from the upper portion of the pillar 46 into the vehicle compartment 48.

A pair of seats 50 (a driver's seat and a passenger seat) is provided in the vehicle compartment 48 so as to be arranged side by side in the vehicle width direction. An occupant who is seated on the seat 50 on the right side of the vehicle (not illustrated) may wear the webbing 18 which is extended from the upper portion of the pillar 46 on the right side of the vehicle into the vehicle compartment 48. An occupant who is seated on the seat 50 on the left side of the vehicle (not illustrated) may wear the webbing 18 which is extended from the upper portion of the pillar 46 on the left side of the vehicle into the vehicle compartment 48.

A lock mechanism 20 which is well known as a lock portion is installed on the opposed plate 14B at one side in the vehicle front-and-rear direction, at the outside of the frame 14. The lock mechanism 20 is operated to restrict taking out rotation of the spool 16. Thus, the taking out of the webbing 18 from the spool 16 can be restricted. Therefore, the webbing 18 can restrict the occupant who wears it.

The acceleration sensor 10 is installed in the lower portion of the lock mechanism 20.

The acceleration sensor 10 has a holder sensor 22 (housing sensor) in a rectangular parallelepiped case shape as an installation portion. One side surface in the vehicle front-and-rear direction of the holder sensor 22 is opened. The upper surface of the holder sensor 22 is opened at least in the other side portion in the vehicle width direction.

The holder sensor 22 is formed with plate shaped installing claws 24 configuring a second installation portion on both side walls in the vehicle width direction. The installing claw 24 can be elastically deformed to the outside of the holder sensor 22. A base end portion 24A (the other side portion in the vehicle front-and-rear direction) and a distal end portion 24B (one side portion in the vehicle front-and-rear direction) of the installing claw 24 are protruded to the inside of the holder sensor 22. One side surface in the vehicle front-and-rear direction of the distal end portion 24B of the installing claw 24 is inclined in the direction toward the inside of the holder sensor 22 while toward the other side in the vehicle front-and-rear direction.

Pairs of installing pillars 26 in a rectangular pillar shape configuring the second installation portion are provided on both side walls in the vehicle width direction on the inner surface of the holder sensor 22. The pair of installing pillars 26 is extended in the vehicle front-and-rear direction just above and just below the installing claw 24.

A planar plate shaped meshing gear 28 as a second engaging portion configuring a changing portion is fixed on the other side wall in the vehicle front-and-rear direction on the inner surface of the holder sensor 22. The meshing gear 28 is protruded to the inside of the holder sensor 22. A predetermined number (three in this exemplary embodiment, but not limited to the same in the present invention, one or more number is possible in the present invention) of meshing teeth 28A are formed on one side surface in the vehicle front-and-rear direction of the meshing gear 28. The predetermined number of meshing teeth 28A configure an internal gear and are arranged with a pitch of a predetermined center angle (e.g., 5°) about the axes of a pair of installing shafts 32 as center described later.

A bracket 30 as a supporting portion is attached in the holder sensor 22. The installing shafts 32 in a circular shaft shape as a first installation portion is provided on both side ends in the vehicle width direction of the bracket 30. The axes of the pair of installing shafts 32 are arranged on the same line parallel to the vehicle width direction. Each of the pair of installing shafts 32 is arranged between the base end portion 24A and the distal end portion 24B of the installing claw 24 so as to prevent movement to both sides in the vehicle front-and-rear direction and to both sides in the vehicle width direction. Each of the pair of installing shafts 32 is arranged between the pair of installing pillars 26 so as to prevent movement to both sides in the up-and-down direction. The bracket 30 is installed in the holder sensor 22 in this way.

A planar plate shaped engaging gear 34 as a first engaging portion configuring the changing portion is provided near one side end in the vehicle width direction of the bracket 30. The engaging gear 34 is arranged perpendicular to the vehicle width direction. Plural engaging teeth 34A are formed on the other side surface in the vehicle front-and-rear direction of the engaging gear 34. The plural engaging teeth 34A configure an external gear and are arranged with a pitch of a predetermined center angle (e.g., 5°) about the axes of the pair of installing shafts 32 as center. The predetermined engaging teeth 34A mesh (engage) with the predetermined number of meshing teeth 28A of the meshing gear 28 of the holder sensor 22 to prevent rotation about the pair of installing shafts 32 as center of the bracket 30.

A supporting body 36 in a substantially semispherical case shape is installed in the lower portion of the bracket 30. The inner portion of the supporting body 36 is opened upward. The inner surface of the supporting body 36 is a supporting surface 36A in a spherical shape (or a conical side surface shape). The center axis of the supporting surface 36A (the axis passing through the center of curvature of the supporting surface 36A and the center of the bottom portion of the supporting surface 36A) is arranged parallel to the up-and-down direction.

A spherical ball 38 as a moving body is accommodated in the supporting body 36. The ball 38 is placed (supported) on the bottom portion (the lower end portion) of the supporting surface 36A and is protruded upward from the supporting body 36.

A pair of supporting plates 40 in a rectangular planar plate shape is provided in standing manner between the engaging gear 34 and the supporting body 36 in the bracket 30. The pair (the supporting plates 40) is opposed to each other in the vehicle front-and-rear direction.

A plate shaped lever 42 as an operating portion is rotatably supported at a rotating shaft 42A in a circular shaft shape between the pair of supporting plates 40. A contacting surface 42B in a conical side surface shape (or a spherical shape) is formed on the lower surface of the lever 42. The lever 42 is placed on the ball 38. The contacting surface 42B is brought into contact with the ball 38.

When the magnitude (absolute value) of an acceleration (including a deceleration) of the vehicle 44 becomes a predetermined value or more (at sudden deceleration of the vehicle 44 and the like), the ball 38 is moved laterally relative to the supporting surface 36A of the supporting body 36 due to the action (inertial force) of the acceleration of the vehicle 44. The ball 38 is moved upward along the supporting surface 36A, so, the lever 42 is rotated (operated) upward by the ball 38. In this way, the acceleration sensor 10 detects that the magnitude of the acceleration of the vehicle 44 becomes the predetermined value or more. The lock mechanism 20 is operated by the upward rotating of the lever 42. So, taking out rotation of the spool 16 is restricted to restrict the taking out of the webbing 18 from the spool 16.

The operation of this exemplary embodiment will be described.

When the bracket 30 (including the ball 38 and the lever 42) is installed in the holder sensor 22 of the thus-configured acceleration sensor 10, the bracket 30 (including the ball 38 and the lever 42) is inserted into the opening in one side surface in the vehicle front-and-rear direction of the holder sensor 22. One side surface in the vehicle front-and-rear direction (the inclining surface) of the distal end portion 24B of each of the pair of installing claws 24 of the holder sensor 22 is pressed by each of the pair of installing shafts 32 of the bracket 30. Thus, the pair of installing claws 24 is temporarily elastically deformed to the outside of the holder sensor 22 by the pair of installing shafts 32, respectively. So, each of the installing shafts 32 is arranged between the base end portion 24A and the distal end portion 24B of each of the installing claws 24. Further, each of the installing shafts 32 is arranged between each of the pairs of installing pillars 26 of the holder sensor 22.

At this time, the meshing teeth 28A of the predetermined number of the meshing gear 28 of the holder sensor 22 mesh with the predetermined engaging teeth 34A of the engaging gear 34 of the bracket 30 to prevent rotation of the bracket 30 about the pair of installing shafts 32 as center. By this, the center axis of the supporting surface 36A of the supporting body 36 of the bracket 30 is arranged parallel to the up-and-down direction. Therefore, the placing state of the ball 38 onto the supporting surface 36A and the operation of the ball 38 due to the action of the acceleration of the vehicle 44 become appropriate. The detecting performance of the acceleration of the vehicle 44 by the acceleration sensor 10 becomes appropriate.

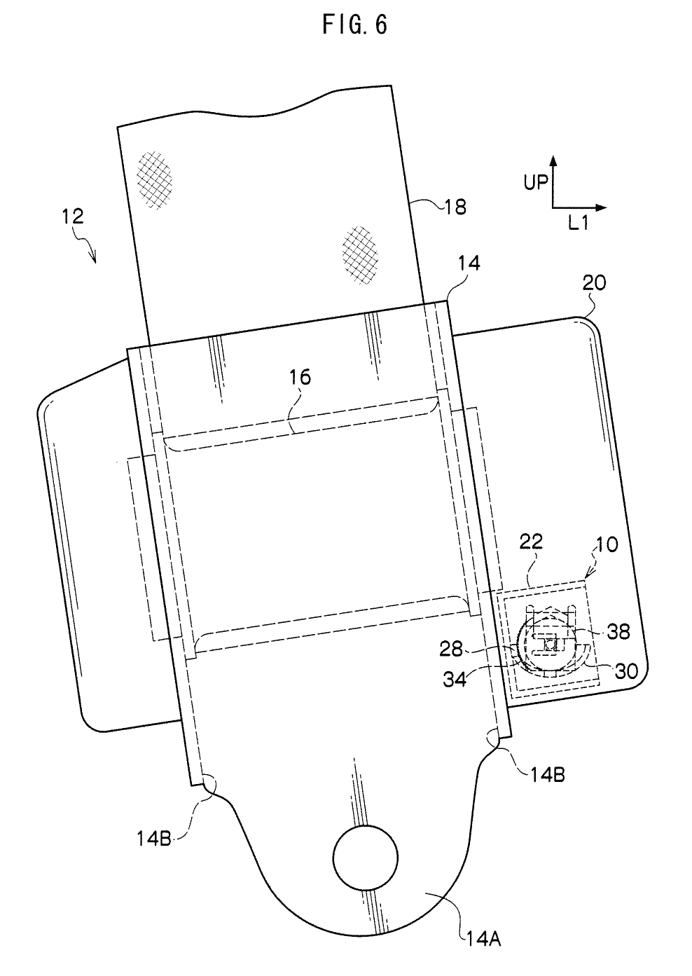

In this exemplary embodiment, the pillar 46 of the vehicle 44 is arranged so as not to be inclined in the vehicle front-and-rear direction. Depending on the type of the vehicle, the pillar 46 is arranged so as to be inclined at various angles in the vehicle front-and-rear direction. The webbing 18 need to be taken out from the spool 16 in the device upward direction along the pillar 46 the in the webbing winding device 12. When the pillar 46 is arranged so as to be inclined at various angles in the vehicle front-and-rear direction, the webbing winding device 12 (including the holder sensor 22) need to be installed such that the device up-and-down direction is inclined at various angles in the vehicle front-and-rear direction along the pillar 46 (see FIG. 6).

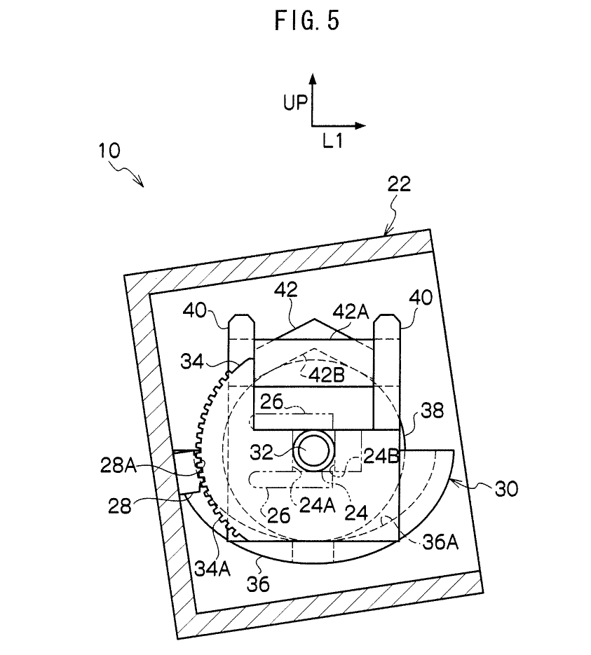

When the webbing winding device 12 (including the holder sensor 22) is installed such that the device up-and-down direction is inclined at an angle in the vehicle front-and-rear direction, adjustment is carried out. That is, the engaging teeth 34A of the engaging gear 34 of the bracket 30 which mesh the meshing teeth 28A of the predetermined number of the meshing gear 28 of the holder sensor 22 are adjusted. So, the installing angle in the vehicle front-and-rear direction of the bracket 30 relative to the holder sensor 22 is adjusted. As the result, the center axis of the supporting surface 36A of the supporting body 36 of the bracket 30 is arranged parallel to the up-and-down direction (see FIG. 5). The detecting performance of the acceleration of the vehicle 44 by the acceleration sensor 10 can be maintained.

In installation of the webbing winding device 12 (including the holder sensor 22), even if the installing angle (including 0°) of the device up-and-down direction relative to the vehicle front-and-rear direction is changed, the center axis of the supporting surface 36A of the supporting body 36 can be arranged parallel to the up-and-down direction without changing the bracket 30, the ball 38, and the lever 42. So, the detecting performance of the acceleration of the vehicle 44 by the acceleration sensor 10 can be maintained. Accordingly, one type of the bracket 30, the ball 38, and the lever 42 can be used irrespective of the model (type) of the vehicle. As the result, when manufacturing the bracket 30, the ball 38, and the lever 42, the mold of one type can be used. The cost may be reduced.

The engaging teeth 34A of the engaging gear 34 which mesh the meshing teeth 28A of the predetermined number of the meshing gear 28 are changed. So, the installing angle in the vehicle front-and-rear direction of the bracket 30 relative to the webbing winding device 12 (the holder sensor 22) is changed and set. By this simple configuration, the installing angle in the vehicle front-and-rear direction of the bracket 30 relative to the webbing winding device 12 (the holder sensor 22) can be changed. Further, the installing angle in the vehicle front-and-rear direction of the bracket 30 relative to the webbing winding device 12 (the holder sensor 22) can be set at high accuracy.

The inclining angles (including 0°) of the pillar 46 on the right side of the vehicle and of the pillar 46 on the left side of the vehicle in the vehicle front-and-rear direction are the same. In each of the pillars 46, one side in the vehicle width direction of the webbing winding device 12 is directed to the inside in the vehicle width direction. In the pillar 46 on the right side of the vehicle, one side in the vehicle front-and-rear direction of the webbing winding device 12 is directed to the rear side of the vehicle. In the pillar 46 on the left side of the vehicle, one side in the vehicle front-and-rear direction of the webbing winding device 12 is directed to the front side of the vehicle. In each of the pillars 46, the inclining angle toward the front side of the vehicle, with respect to the upward direction, of the extending direction of the pillar 46 and the device up-and-down direction of the webbing winding device 12 (including the holder sensor 22) is α (in which the inclining angle toward the front side of the vehicle is a positive angle, the inclining angle toward the rear side of the vehicle is a negative angle, and 0° is included). In this case, the bracket 30 is installed in the holder sensor 22 such that, in the pillar 46 on the right side of the vehicle, the inclining angle to one side in the front-and-rear direction of the center axis of the supporting surface 36A of the supporting body 36 relative to the upper side direction of the webbing winding device 12 (including the holder sensor 22) is α (in which the inclining angle toward one side in the vehicle front-and-rear direction is a positive angle, the inclining angle toward the other side in the vehicle front-and-rear direction is a negative angle, and 0° is included). The bracket 30 is installed in the holder sensor 22 such that, in the pillar 46 on the left side of the vehicle, the inclining angle to the other side in the vehicle front-and-rear direction of the center axis of the supporting surface 36A of the supporting body 36 relative to the upper side direction of the webbing winding device 12 (including the holder sensor 22) is a (in which the inclining angle toward the other side in the vehicle front-and-rear direction is a positive angle, the inclining angle toward one side in the vehicle front-and-rear direction is a negative angle, and 0° is included). In the webbing winding device 12 (the acceleration sensor 10) of each of the pillars 46, the center axis of the supporting surface 36A of the supporting body 36 can be arranged parallel to the up-and-down direction.

In this exemplary embodiment, the meshing gear 28 (the predetermined number of meshing teeth 28A) is provided in the holder sensor 22, and the engaging gear 34 (the plural engaging teeth 34A) is provided in the bracket 30. The engaging gear 34 (the plural engaging teeth 34A) may be provided in the holder sensor 22, and the meshing gear 28 (the predetermined number of meshing teeth 28A) may be provided in the bracket 30. In this case, the engaging teeth 34A configure the internal gear, and the meshing teeth 28A configure the external gear.

What is claimed is:

1. An acceleration sensor comprising:
a supporting portion that supports a moving body such that the moving body can be moved by action of a predetermined acceleration of a vehicle;
an installation portion to which the supporting portion is installed, a setting angle of the installation portion relative to the vehicle being changed according to a model of the vehicle; and
a changing portion that can change an installing angle of the supporting portion relative to the installation portion according to the model of the vehicle.

2. The acceleration sensor of claim 1, wherein
the changing portion includes:
a first engaging portion that is provided at one of the supporting portion or the installation portion; and
a second engaging portion that is provided at the other of the supporting portion or the installation portion, and engages with the first engaging portion, and
by changing an engaging state of the first engaging portion and the second engaging portion, the installing angle of the supporting portion relative to the installation portion is changed.

3. The acceleration sensor of claim 2, wherein
the second engaging portion includes at least one tooth,
the first engaging portion includes a plurality of teeth which can engage with the tooth of the second engaging portion, and
by changing the tooth of the first engaging portion which engages with the tooth of the second engaging portion, the installing angle of the supporting portion relative to the installation portion is changed.

4. The acceleration sensor of claim 3, wherein
the second engaging portion is fixed to the installation portion, and
the first engaging portion is provided at the supporting portion.

5. The acceleration sensor of claim 3, wherein
the first engaging portion is fixed to the installation portion, and
the second engaging portion is provided at the supporting portion.

6. The acceleration sensor of claim 2, wherein
the second engaging portion configures an internal gear,
the first engaging portion configures an external gear that engages with the internal gear, and
by changing the engaging state of the internal gear of the second engaging portion and the external gear of the first engaging portion, the installing angle of the supporting portion relative to the installation portion is changed.

7. The acceleration sensor of claim 6, wherein
the internal gear includes at least one tooth,
the external gear includes a plurality of teeth which can engage with the tooth of the internal gear, and
by changing the tooth of the external gear which engages with the tooth of the internal gear, the installing angle of the supporting portion relative to the installation portion is changed.

8. The acceleration sensor of claim 7, wherein
the internal gear is fixed to the installation portion, and
the external gear is provided at the supporting portion.
